(19) United States
(12) Patent Application Publication
(10) Pub. No.: US 2011/0065870 A1
(43) Pub. Date: Mar. 17, 2011

(54) Tris(Hydroxoxyphenyl) Phosphine Oxides and their Use as Flame Retardants for Epoxy Resins

(75) Inventors: Larry D. Timberlake, West Lafayette, IN (US); Mark V. Hanson, West Lafayette, IN (US); James D. Sibecker, West Lafayette, IN (US)

(73) Assignee: Chemtura Corporation, Middlebury, CT (US)

(21) Appl. No.: 12/857,785

(22) Filed: Aug. 17, 2010

Related U.S. Application Data
(60) Provisional application No. 61/241,552, filed on Sep. 11, 2009.

(51) Int. Cl. C08L 71/03; C09K 3/00

(52) U.S. Cl. 525/403; 252/182.14

(57) ABSTRACT

A mixture of tris(hydroxyphenyl) or tris(alkoxyphenyl) phosphine oxide isomers is provided each having the formula (I):

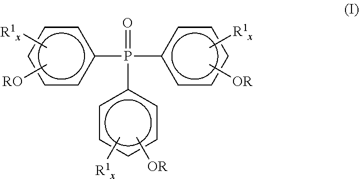

wherein R is hydrogen or an alkyl group containing from 1 to 6 carbon atoms, R¹ is an alkyl group containing from 1 to 6 carbon atoms, x is an integer between 0 and 4, and each OR group is in the ortho or para position with respect to the bond between the P atom and the associated phenyl group such that the ratio of the number of OR groups in the ortho-position with respect to the bond between the P atom and the associated phenyl group to the number of OR groups in the para-position with respect to the bond between the P atom and the associated phenyl group is between about 50:50 and about 0.1:99.9.

This application claims the benefit of the filing date of U.S. Provisional Application No. 61/241,552, filed Sep. 11, 2009, the entire contents of which are incorporated herein by reference. This invention relates to tris(hydroxyphenyl) phosphine oxides and tris(alkoxyphenyl) phosphine oxides and their use as flame retardants for epoxy resins.

### FIELD

### Background

Composite materials based on epoxy resins are used in a variety of applications and continue to have considerable importance because of their versatility. A specific example of such an application is in the production of electrical laminates used in printed circuit boards (printed wiring boards, PWB). A key requirement of this and many other applications is flame resistance. Accordingly, it has been customary in the preparation of epoxy-containing laminates to incorporate various additives to improve the flame retardancy of the resulting laminate. Many types of flame retardant substances have been used, however, the most common thus far used commercially have been halogen containing compounds, such as tetrabromobisphenol A. Typically, in order to reach the desired fire retardancy level (V-0 in the standard “Underwriters Laboratory” test method UL 94), levels of such bromine-containing flame retardant substances are required that provide a bromine content from 10 weight percent to 25 weight percent based on the total weight in the product.

Generally, halogen-containing fire retardant epoxy resins, such as those containing tetrabromobisphenol A, are considered to be safe and effective. However, there has been increasing interest in the industry to utilize flame-retarded epoxy systems that are not based on halogen chemistry. However, these replacement materials must still be able to meet the requirements of fire retardancy and to display the same advantages of mechanical properties, toughness, and solvent and moisture resistance that are offered by the halogenated materials currently used.

One alternative approach has been the use of phosphorus based fire retardants. See for example, EP 0 384 939 and U.S. Pat. Nos. 5,817,736; 5,759,690; 5,756,638, 5,648,171; 5,587,243; 5,576,357; 5,458,978; 5,376,453; and 5,036,135; all of which are incorporated herein by reference in their entirety. In all of these references, a formulation is formed from the reaction of a flame retardant derived from a phosphorus compound and an epoxy resin, which is then cured with an amino cross-linker such as dicyandiamide, sulfanilamide, or some other nitrogen element containing cross-linker to form the thermosetting polymer network.

Specific examples of commercially available phosphorus-based fire retardant additives include Antiblaze® 1045 (Albright and Wilson Ltd, United Kingdom) which is a phosphonic acid ester. Phosphoric acid esters have also been used as additives, such as, for example, PX-200 (Diahachi, Japan). Other commercially available reactive phosphorus containing compounds disclosed as being suitable for epoxy resins include Sanko HCA and Sanko HCA-HQ (Sanko Chemical Co., Ltd., Japan).

Alkyl and aryl substituted phosphonic acid esters are particularly compatible with epoxy resins. However, these phosphonic acid esters are often unsatisfactory as substitutes for halogenated flame retardants in epoxy resins for the production of electrical laminates. For example, these materials are known to be plasticizers and thus laminates formed therefrom lend to exhibit undesirably low glass transition temperatures (Tg). An additional drawback is that the use of phosphonic acid esters in amounts sufficient to provide the necessary flame retardancy increases the tendency of the resulting cured epoxy resin to absorb moisture. The moisture absorbency of cured laminate board is very significant, because laminates containing high levels of moisture tend to blister and fail, when subjected to the soldering operations typically employed in the manufacture of printed wiring boards.

Various other phosphorus based flame retardant materials are described in the literature, which are either too expensive or feature certain inferior properties. For example, EP 0 754 728 discloses a cyclic phosphonate as a flame retardant material for an epoxy resin. However, the cyclic phosphonate must be present in large quantities, such as in excess of 18 weight percent, in order for the resin system to meet UL 94 V-0 rating. This loading for the phosphonate compound may lead to a depression of the Tg or higher moisture absorption. EP 1 116 774 utilizes a hydrogen phosphinate, 9,10-dihydro-9-oxa-10-phosphaphenanthrene-10-oxide, in conjunction with triphenylphosphine oxide. However, the epoxy resin base requires the use of non-standard epoxy resins; namely a xylene-modified novolak resin and naphthylene aralkyl and biphenyl-modified epoxy resins.

Various other phosphorus compounds have also been used to prepare halogen-free flame retardant epoxy resins useful in the manufacture of composite materials. For example, the use of phosphorus-carbon bonded moieties, such as phosphine oxides, have been disclosed in WO 01/42253; U.S. Pat. No. 4,345,059; EP 1 116 774; JP2000186186 and JP 05057991B4; all of which are incorporated herein by reference in their entirety. Such phosphine oxides display benefits of improved resistance to moisture uptake when compared with other phosphorus compounds that contain P—O bonded moieties, as disclosed in WO 01/42253. However, a key disadvantage of these compositions is that they are costly to prepare, because they utilize unique raw materials. For example, JP2000186186 discloses the use of pure bis(p-hydroxyphenyl)phenyl-phosphine oxide, which requires the use of a pure dichlorophenyl phosphine in its production. Similarly, JP 05057991B4 discloses the production of tris-(m-gylcidyloxyphenyl)phosphine oxide by reacting the pure meta phenol with epichlorohydrin. In an analogous manner, the phosphine oxides utilized in WO 01/42253 require lithium reagents and cryogenic reaction conditions, thus requiring special equipment for their manufacture.

In U.S. Pat. No. 6,733,698 there is disclosed a mixture of hydroxyarylphosphine oxides comprising (a) a mono(hydroxyaryl)phosphine oxide, (b) a bis(hydroxyaryl)phosphine oxide, (c) a tris(hydroxyaryl)phosphine oxide, and, optionally (d) a tri-aryl, alkyl or aralkyl-substituted phosphine oxide. The mixture is produced by reacting a mixed Grignard reagent with phosphorus oxychloride and is said to be useful in the preparation of polyglycidyl ethers and as a flame retardant in epoxy resin compositions which can be processed into resin-impregnated composites.

U.S. Pat. No. 6,740,732 discloses phosphorus element-containing crosslinking agents for epoxy resin compositions based on isomeric mixtures of tris(2-hydroxyphenyl)phosphine oxides having the following general chemical structure:

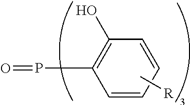

wherein R may be independently a hydrogen or a C₁-C₁₀ alkyl group.

According to the present invention, a novel mixture of ortho and para tris(hydroxyphenyl) phosphine oxide isomers has been developed and has been shown to be useful as a flame retardant in epoxy resin formulations. The mixture can be produced from the direct reaction product of the manufacture of anisole from phenol and methyl bromide and hence is significantly less expensive to produce than many of the phosphorous containing flame retardants suggested in the prior art.

### SUMMARY

In one aspect, the invention resides in a mixture comprising a plurality of tris(hydroxyphenyl) or tris(alkoxyphehyl) phosphine oxide isomers each having the formula (I):

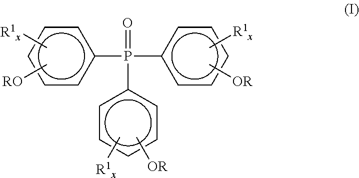

wherein R is hydrogen or an alkyl group containing from 1 to 6 carbon atoms, R¹ is an alkyl group containing from 1 to 6 carbon atoms, x is an integer between 0 and 4, and each OR group is in the ortho or para position with respect to the bond between the P atom and the associated phenyl group such that the ratio of the number of OR groups in the ortho-position with respect to the bond between the P atom and the associated phenyl group to the number of OR groups in the para-position with respect to the bond between the P atom and the associated phenyl group is between about 50:50 and about 0.1:99.9, preferably between about 20:80 and about 1:99.

Conveniently, x is zero and R is hydrogen.

In a further aspect, the invention resides in a method of producing a mixture of tris(alkoxyphenyl) phosphine oxide isomers each having the formula (I), the method comprising:

(a) reacting phenol with an alkyl halide having 1 to 6 carbon atoms in the presence of an alkali metal base to produce a first product mixture comprising an alkoxybenzene and an alkali metal halide;

(b) contacting said first product mixture with an oxidizing agent under conditions such that the alkali metal halide reacts with the alkoxybenzene to produce a mixture of meta and para-haloalkoxybenzenes; and

(c) reacting said mixture of meta and para-haloalkoxybenzenes with magnesium and with phosphorus oxychloride to produce said mixture wherein R in formula (I) is an alkyl group containing from 1 to 6 carbon atoms.

Conveniently, the alkyl halide comprises methyl bromide and the oxidizing agent comprises hydrogen peroxide.

In one embodiment, the method further comprises reacting the product of (c) with an acid to produce the corresponding mixture of tris(hydroxyphenyl) phosphine oxides wherein R in formula (I) is hydrogen.

In yet a further aspect, the invention resides in an epoxy resin composition comprising the reaction product of a mixture of tris(hydroxyphenyl) phosphine oxide isomers each having the formula (I), wherein R is hydrogen, and an epihalohydrin.

In still yet a further aspect, the invention resides in a curable epoxy resin composition comprising (a) an epoxy resin and (b) a cross-linking system comprising a mixture of tris(hydroxyphenyl) phosphine oxide isomers each having the formula (I), wherein R is hydrogen.

### DETAILED DESCRIPTION

Described herein is a mixture of tris(hydroxyphenyl) or tris(alkoxyphenyl) phosphine oxide isomers each having the formula (I):

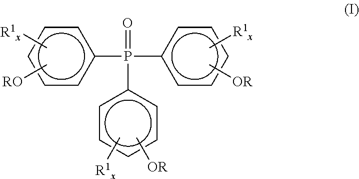

wherein R is hydrogen or an alkyl group containing from 1 to 6 carbon atoms, R¹ is an alkyl group containing from 1 to 6 carbon atoms, x is an integer between 0 and 4, and each OR group is in the ortho or para position with respect to the bond between the P atom and the associated phenyl group such that the ratio of the number of OR groups in the ortho-position with respect to the bond between the P atom and the associated phenyl group to the number of OR groups in the para-position with respect to the bond between the P atom and the associated phenyl group is between about 50:50 and about 0.1:99.9, preferably between about 20:80 and about 1:99, and most preferably between about 10:90 and 2:98.

Generally, R in formula (I) is hydrogen or an alkyl group containing from 1 to 3 carbon atoms, especially hydrogen or a methyl group. As will become apparent from the ensuing discussion, in its as-synthesized form, the present mixture will generally comprise isomers of formula (I) in which R is an alkyl group. However, before use of the mixture in the production of an epoxy resin, the mixture is generally converted to an active form, in which some or all of the R groups are hydrogen. Such conversion is readily achieved by treating the mixture with an acid, such as hydrogen bromide.

Generally, R¹ in formula (I) is an alkyl group containing from 1 to 3 carbon atoms, especially a methyl group. However, x in formula (I) is generally either zero or 1, especially zero.

Thus, in one practical embodiment the present composition comprises a mixture of tris(hydroxyphenyl) or tris(alkoxyphenyl) phosphine oxide isomers each having the formula (II):

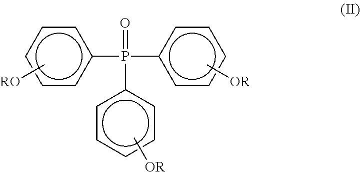

The present mixture can readily be produced by a process in which phenol is initially reacted with an alkyl halide having 1 to 6 carbon atoms, generally methyl bromide, in the presence of an alkali metal base, such as sodium or potassium hydroxide, to produce a first product mixture comprising an alkoxybenzene and an alkali metal halide. The reaction is typically conducted at a temperature of about 50° C. to about 90° C. for about 1 to about 3 hours and can be represented as follows:

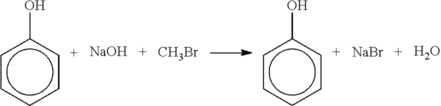

The first product mixture is then contacted with an oxidizing agent, such as hydrogen peroxide, under conditions such that the alkali metal halide reacts with the alkoxybenzene to produce a mixture of meta and para-haloalkoxybenzenes. The oxidation reaction is typically conducted at a temperature of about 20° C. to about 40° C. for about 1 to about 4 hours and can be represented as follows:

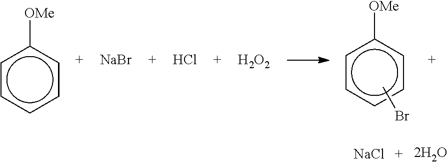

The resulting mixture of meta and para-haloalkoxybenzenes, is isolated by phase separation and, optionally, distillation, without separation of the individual isomers, and then dried to remove trace moisture. For the case of meta- and para-bromoanisole, the isomers have the same boiling points. The dried mixture of meta and para-haloalkoxybenzenes is then reacted with magnesium followed by phosphorus oxychloride to produce the required mixture of formula (I) wherein R is an alkyl group containing from 1 to 6 carbon atoms. The reaction is a Grignard type reaction and is typically conducted by adding the haloalkoxybenzene mixture to a suspension of magnesium in an ether-based solvent at a 1:1 molar ratio. Then the phosphorus oxychloride is added to the formed Grignard reagent at a molar ratio of at least 1:3 (POCl₃:Grignard). The reaction is generally carried out at a temperature of about 60° C. to about 110° C. for about 1 to about 3 hours for each step and can be represented overall as follows:

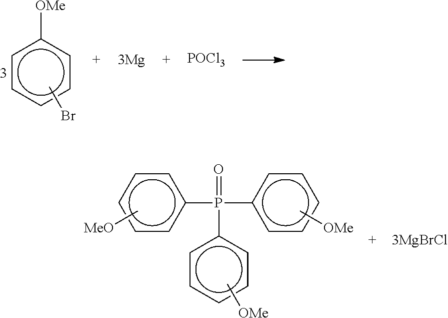

The resulting mixture of tris(alkoxyphenyl) phosphine oxide isomers can be converted to a mixture of tris(hydroxyphenyl) phosphine oxide isomers by reacting the as-synthesized product with an acid, normally hydrogen bromide. This is conveniently effected by refluxing the tris(alkoxyphenyl)phosphine oxide isomers with 48% HBr for several hours and not only converts the product to its active hydroxyl form but also generates alkyl bromide, in this case methyl bromide, that can be recycled to the initial reaction with phenol.

The present mixture of tris(hydroxyphenyl) phosphine oxide isomers can be used either (a) directly to produce curable, flame retardant epoxy resins or (b) as a crosslinking agent for epoxy resins to produce cured, flame retardant epoxy resin compositions.

To produce curable, flame retardant epoxy resins, the present mixture of tris(hydoxyphenyl) phosphine oxide isomers is conveniently reacted with an epihalohydrin, such as epichlorohydrin, to produce the corresponding glycidyl ether derivatives. These ether derivatives are epoxy resins and can be cured with standard hardeners such as a combination of dicyandiamide and 2-methylimidazole. The present phenolic mixtures can also act as hardeners themselves. Other phenolic hardeners include, but are hot limited to, phenolic resins obtained from the reaction of phenols or alkyl-substituted phenols with formaldehyde, such as phenol novolaks, cresol novolaks, and resoles. Other hardeners include amines, anhydrides, and combinations involving amines with Lewis acids. Amine hardeners include, but are not limited to, alkyl amines, aryl amines, amides, biguanide derivatives, melamine and guanamine derivatives, methylene-dianiline, diaminodiphenylsulfone, imidazoles, ethylenediamine, diethylenetriamine, poly amides, polyamidoamines, imidazolines, polyetheramines, araliphatic amines, dicyandiamide, and m-phenylenediamine. Combinations of nitrogen-containing catalyst with Lewis acids include the heterocyclic secondary and tertiary amines and the Lewis acids include oxides and hydroxides of zinc, tin, silicon, aluminum, boron, and iron. Other curing agents include carboxylic acids and anhydrides, amino-formaldehyde resins, and amine-boron complexes. Many types of curing agents that would be useful can be found in any basic epoxy resin text. In addition, the resins described herein may be formulated with additional additives and fillers to affect cure rate, enhance flame retardancy, and increase the physical properties of the cured epoxy resin composition.

Typically, fillers and reinforcing agents include mica, talc, kaolin, bentonite, wollastonite, glass fiber, glass fabrics glass matt, milled glass fiber, glass beads (solid or hollow), silica, or silicon carbide whiskers and so forth. Many of these materials are enumerated in the Encyclopedia of Materials Science and Engineering, Vol. #3, pp. 1745-1759, MIT Press, Cambridge, Mass. (1986), the disclosure of which is incorporated herein by reference. Combinations of fillers are preferred in some embodiments; whereas in other embodiments, the reinforcing agent makes up most of the final composite, as in the case of glass fabric used in prepregs and laminates for printed wiring boards.

Additionally, the curable epoxy resin described herein may be formulated with other flame-retardant materials as co-additives to improve their performance. These co-FR materials could be either inorganic or organic and can be reactive or additive based compounds. Examples of inorganic additive type materials include, but are not limited to, aluminum trihydrate (ATM), magnesium hydroxide, barium hydroxide, calcium carbonate, titanium dioxide, arid silicon dioxide. Examples of organic based additives or reactives include, but are not limited to, triphenyl phosphate, resorcinol bis(di-2,6-xylyl phosphate), 9,10-dihydro-9-oxa-10-phosphaphenanthrene-10-oxide (DOPO), DOPO-based epoxy resins, bisphenol A bis(diphenyl-phosphate), melamine, melamine phosphate, melamine borate and many others familiar to one skilled in the art.

Alternatively, the present mixture of tris(hydroxyphenyl) phosphine oxide isomers can be used as a crosslinking agent for epoxy resins, either alone or in combination with a phenolic co-crosslinking composition. Suitable phenolic co-crosslinking compositions comprise novolac resins, such as phenol-formaldehyde resins, cresol-formaldehyde resins, and mixtures thereof. A polymer of a phenol, nitrogen heleroaryl compound and aldehyde is also suitable. Examples include benzoguanamine-phenol-formaldehyde resins, acetoguanamine-phenol-formaldehyde resins, melamine-phenol-formaldehyde resins, benzoguanamine-cresol-formaldehyde resins, acetoguanamine-cresol-formaldehyde resins, melamine-cresol-formaldehyde resins, and mixtures thereof.

Representative epoxy resins suitable for use with the present mixture of tris(hydroxyphenyl) phosphine oxide isomers are presented in Epoxy Resins Chemistry and Technology, Second Edition edited by Clayton A. May (Marcel Dekker, Inc. New York, 1988), Chemistry and Technology of Epoxy Resins edited by B. Ellis (Blackie Academic & Professional, Glasgow, 1993), Handbook of Epoxy Resins by H. E. Lee and K. Neville (McGraw Hill, New York, 1967), and EP 1116774 A2. Suitable epoxy resins are, but not limited to, epoxy resins based on bisphenols and polyphenols, such as, bisphenol A, tetramethylbisphenol A, bisphenol F, bisphenol S, tetrakisphenylolethane, resorcinol, 4,4′-biphenyl, dihydroxynaphthylene, and epoxy resins derived from novolacs, such as, phenol:formaldehyde novolac, cresol:formaldehyde novolac, bisphenol A novolac, biphenyl-, toluene-, xylene, or mesitylene-modified phenol:formaldehyde novolac, aminotriazine novolac resins and heterocyclic epoxy resins derived from p-amino phenol and cyanuric acid. Additionally, aliphatic epoxy resins derived from 1,4-butanediol, glycerol, and dicyclopentadiene skeletons, are suitable, for example. Many other suitable epoxy resin systems are available and would also be recognized as being suitable by one skilled in the art.

It is generally advantageous to use an epoxy resin which possesses on average more than 1 and preferably at least 1.8, more preferably at least 2 epoxy groups per molecule. In the most preferred case the epoxy resin is a novolac epoxy resin with at least 2.5 epoxy groups per molecule. In the broadest aspect of the invention, the epoxy resin may be any saturated or unsaturated aliphatic, cycloaliphatic, aromatic or heterocyclic compound which possesses more than one 1,2-epoxy group. Examples of heterocyclic epoxy compounds are diglycidylhydantoin or triglycidyl isocyanurate (TGIC).

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A mixture comprising a plurality of tris(hydroxyphenyl) or tris(alkoxyphenyl) phosphine oxide isomers each having the formula (I): 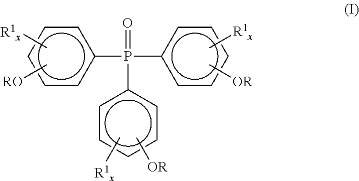
wherein R is hydrogen or an alkyl group containing from 1 to 6 carbon atoms, R¹ is an alkyl group containing from 1 to 6 carbon atoms, x is an integer between 0 and 4, and each OR group is in the ortho or para position with respect to the bond between the P atom and the associated phenyl group such that the ratio of the number of OR groups in the ortho-position with respect to the bond between the P atom and the associated phenyl group to the number of OR groups in the para-position with respect to the bond between the P atom and the associated phenyl group is between about 50:50 and about 0.1:99.9.

2. The mixture of claim 1, wherein the ratio of the number of OR groups in the ortho-position with respect to the bond between the P atom and the associated phenyl group to the number of OR groups in the para-position with respect to the bond between the P atom and the associated phenyl group is between about 20:80 and about 1:99.

3. The mixture of claim 1, wherein x is zero.

4. The mixture of claim 1, wherein R is hydrogen.

5. A method of producing the mixture of claim 3, the method comprising:
(a) reacting phenol with an alkyl halide having 1 to 6 carbon atoms in the presence of an alkali metal base to produce a first product mixture comprising an alkoxybenzene and an alkali metal halide;
(b) contacting said first product mixture with an oxidizing agent under conditions such that the alkali metal halide reacts with the alkoxybenzene to produce a mixture of meta and para-haloalkoxybenzenes; and
(c) reacting said mixture of meta and para-haloalkoxybenzenes with magnesium and with phosphorus oxychloride to produce said mixture wherein R in formula (I) is an alkyl group containing from 1 to 6 carbon atoms.

6. The method of claim 5, wherein the alkyl halide comprises methyl bromide.

7. The method of claim 5, wherein said oxidizing agent comprises hydrogen peroxide.

8. The method of claim 5 and further comprising reacting the product of (c) with an acid to produce said mixture wherein R in formula (I) is hydrogen.

9. An epoxy resin composition comprising the reaction product of the mixture of claim 4 and an epihalohydrin.

10. A curable epoxy resin composition comprising (a) an epoxy resin and (b) a cross-linking system comprising the mixture of claim 4.
